(19) United States
(12) Patent Application Publication
(10) Pub. No.: US 2010/0276505 A1
(43) Pub. Date: Nov. 4, 2010

(54) DRILLING IN STRETCHED SUBSTRATES

(76) Inventor: Roger Earl Smith, Bagsvaerd (DK)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/678,114

(22) PCT Filed: Sep. 26, 2008
(86) PCT No.: PCT/US08/11199

§ 371 Date: Mar. 12, 2010

Related U.S. Application Data
(60) Provisional application No. 60/975,221, filed on Sep. 26, 2007.
(60) Provisional application No. 60/982,759, filed on Oct. 26, 2007.
(60) Provisional application No. 61/023,906, filed on Jan. 28, 2008.

(51) Int. Cl. B05B 1/14; B05B 17/00; B23K 26/38; B05B 1/26

(52) U.S. Cl. 239/8; 408/19; 219/121.71; 239/543

(57) ABSTRACT

The present invention provides a method and apparatus for drilling a plurality of holes in a stretched substrate in at least two directions not in the same plane, including providing a substrate in a substrate holder, stretching the substrate in at least one direction to a stretched configuration, and drilling at least one hole in the substrate while in a stretched configuration. The present invention further provides methods and apparatus for drilling impinging jet nozzles in stretched or pre-stretched substrates.

### CROSS-REFERENCE

This application is a 371 National Phase of International Application No. PCT/US2008/011199, filed Sep. 26, 2008, which claims priority to U.S. Provisional Application Ser. No. 60/975,221 filed Sep. 26, 2007, U.S. Provisional Application Ser. No. 60/982,759 filed Oct. 26, 2007, and U.S. Provisional Application Ser. No. 61/023,906 filed Jan. 28, 2008, all of which are incorporated herein by reference in their entirety noting that the current application controls to the extent there is any contradiction with any earlier application and to which applications we claim priority under 35 USC §120.

### FIELD OF THE INVENTION

This invention is directed to methods and apparatus for drilling holes in stretched or pre-stretched substrates to create nozzles, and methods and apparatus for drilling holes to create impinging jet nozzles, and combinations thereof.

### BACKGROUND OF THE INVENTION

It is desirable in different areas of technology to make use of a thin sheet of material which has an array of regularly spaced, very small holes therein. For example, such might be used in the manufacture of various electronic components. Thin sheets which have one or more holes could also be used in the formation of components used in ink jet printers or fuel injectors. A more direct application of such a pore array is as a filter. The pore size and pore density could be adjusted for a wide range of filter applications.

Currently, known methods and devices for drilling holes in substrates include U.S. Pat. No. 6,585,926, which discloses a method of manufacturing a porous elastic membrane that may be used in a balloon assembly of a balloon catheter. In the method, an elastic membrane material is expanded beyond an intended deployment expansion to a hyper-expanded state. Apertures are then formed in the hyper-expanded material. After contraction, the now-porous membrane can be used to form the outer wall of the balloon assembly. An aperture formed in the hyper-expanded membrane will have a smaller diameter than when the balloon is inflated to a smaller deployment expansion in the patient's body.

U.S. Pat. No. 6,666,810 (family member being WO 00/76758) discloses a worktable (10) that can be used to support a substrate while forming a hole therein. The worktable may include one or more actuators that stretch the substrate (12). The worktable may also have a control unit (34) that is connected to the actuators (20) and strain gauges (32) that sense the strain in the substrate. The control unit, actuators and strain gauges may provide a closed loop control system for tensioning the substrate. The center portion of the substrate may be supported by wires that extend across an opening in the worktable. The opening eliminates a backing surface that may interfere with a laser hold forming process.

EP 0 712 615 B1 (U.S. family member being U.S. Pat. No. 5,707,385) discloses an expandable sheath provided for delivering a therapeutic drug in a body lumen which comprises an expandable membrane with a therapeutic drug incorporated therein. The expandable membrane is in a cylindrical configuration and mounted on the balloon portion of a catheter for intraluminal drug delivery into a patient's vascular system. The expandable membrane may also be mounted on an intravascular stent, both of which are implanted within the patient's vascular system. The therapeutic drug then diffuses into the vascular system at a controlled rate to match a specific clinical need.

However, the above noted documents fail to disclose at least generation of an aerosol from the holes formed in the substrates. Thus, the present invention provides for at least liquid formulations containing a drug could be moved through such a porous member to create an aerosol for inhalation.

One method of administering an agent to a patient is via aerosol. Aerosol therapy can be accomplished by aerosolization of a formulation (e.g., a drug formulation or diagnostic agent formulation) and administration to the patient, for example via inhalation. The aerosol can be used to treat lung tissue locally and/or be absorbed into the circulatory system to deliver the drug systemically. Where the formulation contains a diagnostic agent, the formulation can be used for diagnosis of, for example, conditions and diseases associated with pulmonary dysfunction.

In general, aerosolized particles for respiratory delivery have a diameter of 12 micrometers or less. However, the preferred particle size varies with the site targeted (e.g., delivery targeted to the bronchi, bronchia, bronchioles, alveoli, or circulatory system). For example, topical lung treatment can be accomplished with particles having a diameter in the range of 1.0 to 12.0 micrometers. Effective systemic treatment by inhalation may require particles having a smaller diameter, generally in the range of 0.25 to 6.0 micrometers, while effective ocular treatment is adequate with particles having a diameter of 15 micrometers or greater, generally in the range of 15-100 micrometers.

Typically during use, moving liquid formulations containing a drug through a porous substrate membrane (i.e., a membrane having a pore array) to create an aerosol for inhalation, typically requires high operating pressures (i.e., greater than 250 psi) which cause the porous membrane to substantially balloon outward. While this ballooning may be into an air flow and as such be advantageous from an aerodynamic point of view, the porous membrane stretches substantially during this process, which can result in enlarged nozzle holes that may result in several drawbacks.

Aerosol can be generated from jetting liquid as the jet becomes unstable or spontaneously breaks up into droplets. This is typically known as Raleigh break-up or instability. Typically in practice, aerosol particle size is a function of nozzle hole size. Thus, the initial droplet size is frequently described as being approximately 1.8 times the initial jet diameter. However, one drawback is that stretched holes result in larger aerosol particles. This can result in a requirement of using a heater in the device to evaporate the particles to reduce size. Simply drilling smaller holes in the membrane prior to stretching during use can be limited by the optical properties of LASER hole drilling, coupled with the fact these smaller drilled holes can themselves stretch to a larger size during use. Moreover, although drilled nozzle hole size can be closely controlled, the functional hole size, i.e., the stretched nozzle hole size present when the device is actually generating aerosol, is a result of many variables such as membrane thickness, material properties, fluid properties, temperature, etc. This can potentially lead to system variability.

Likewise, jetting from small hole sizes requires substantial energy that can result in an aerosol with appreciable velocity. Such a high speed aerosol can require careful airway design to effectively deliver aerosol to the patient and can limit device design options.

Aerosols can also be created using other methods/apparatus, one example is jet impingement, as disclosed in U.S. Pat. No. 5,472,143, which discloses a nozzle assembly for use in atomizing and generating sprays from a fluid. The nozzle assembly includes two members joined together. In one of the two members are formed one or more nozzle outlets, one or more fluid inlets, and a plurality of channels that form filter passageways. The nozzle outlets discharge fluid jets that impinge on one another to thereby atomize the fluid. Alternatively, an impact element or a vortex-generating structure can be used in the nozzle outlet to atomize the fluid.

However, the above noted document utilizes a complicated nozzle assembly, which can result in a cumbersome overall device construction and design, and which may lead to nozzle clogging.

### SUMMARY OF THE INVENTION

A method of drilling a plurality of holes in a stretched or deformed substrate in order to produce a porous membrane which can be used for aerosolized delivery of a drug as disclosed. The method comprises providing a substrate which is held in place in a substrate holder which holder can clamp edges of the substrate which substrate material may be comprised of a thin sheet of any material and is preferably comprised of a polymeric compound. The substrate is held and it is subjected to stretching in two or more directions. The substrate may be stretched in a first direction which is the width of the substrate. The substrate may also be stretched along its length or along its width and at the same time stretched within a different plane which would be the plane making up the depth of the substrate. While the substrate is held in the stretched position a plurality of holes are drilled into the substrate. The substrate is then released from its holder and used to create aerosols.

The substrate produced in accordance with the method of the invention may be combined with a package which holds a flowable liquid which can be collapsed in order to force the liquid through the holes of the substrate. When the liquid is forced through the holes of the substrate the substrate is deformed by the pressure applied. In one embodiment the pressure applied by the liquid being forced through the substrate deforms the substrate to the same degree (±20%) the substrate was deformed during the stretching process. Thus, the holes have a size and alignment which is substantially equivalent to the size and alignment of the holes when the substrate was stretched and drilled, i.e. the size and alignment of the holes during the stretching and drilling matches the size and alignment of the holes when the liquid formulation is forced through the substrate during use.

In view of the above noted disadvantages, the present invention relates to generating nozzles (i.e., holes) in a flexible or deformable membrane or substrate that retain the above-noted advantages while minimizing the effect of nozzle stretching. This technology will herein be referred to as Drill After Stretch (DAS) or Drill After Deform (DAD) technology. Instead of drilling nozzles (e.g., using LASER technologies) into a typical flat membrane or substrate, DAS/DAD technology seeks to pre-stretch and/or pre-deform the membrane or substrate to the final operating shape or near final operating shape, prior to or during drilling. The present invention also relates to generation of aerosol from substrates made using DAS/DAD technology which aerosols are used to treat patients. In this way, the hole size during aerosol generation can be made smaller and can be controlled within a narrower range as compared to not using DAS.

Thus, the present invention provides a method and apparatus for drilling holes in substrates which substrates are pulled in at least two directions not in the same plane prior to or during formation of the nozzles, and generation of aerosol through the substrates.

In addition, it has heretofore been unknown to use jet impingement technology in combination with the Drill After Stretch (DAS) or Drill After Deform (DAD) technology described herein. Thus, combining jet impingement technology with Drill After Stretch (DAS) or Drill After Deform (DAD) technology as described herein may reduce the above noted disadvantages for example by: (1) generating a low velocity aerosol to permit wider device design latitude, (2) allow the use of larger nozzles, and/or (3) provide a desirable aerosol by pressurizing a fluid through the nozzles at lower pressures than previously known.

The present invention is well-suited for providing a porous membrane nozzle useful in a method and apparatus for aerosolizing drugs, hormones, and medications, such as insulin, for pulmonary delivery, for example as disclosed in U.S. Pat. Nos. 5,672,581; 5,873,358; 5,888,477; 5,915,378; 5,970,973; 6,024,090; 6,098,615; 6,131,567; 6,250,298; 6,431,166; 6,427,681; 6,431,167; 7,021,309; 7,028,686, the contents of which are incorporated herein by reference in their entirety. In addition, the present invention can also be used in other areas and for other purposes. Such non-limiting examples include blind holes, nozzles or via holes in circuit board technologies.

Moreover, the present invention further contemplates delivery of active ingredients such as drugs, hormones, and medications, such as insulin through the nozzles for pulmonary administration/absorption. Exemplary active ingredients can include GLP-1, insulin, growth hormones, interferon, and cytokine. “Insulin” mentioned herein broadly refers to not only a normal insulin, but also insulin analogues and insulin derivatives. Examples of insulins include insulin, products thereof with modified amino acid sequences such as insulin aspart, insulin lispro, insulin glargine and insulin detemir. In addition, any peptide portion of insulins mentioned above, which has the whole or part of the main structure of the above substance and at least part of biological characteristics of insulin, can be also used. “GLP-1” mentioned herein broadly refers to not only a normal GLP-1, but also GLP-1 analogue(s). In addition, active ingredients for treating deep lung diseases can include antibiotics, steroid, anticholinergic agents, and B2 stimulants. It should be understood that the active ingredient can be administered by itself, or together in combination with other active ingredients, and any pharmaceutically acceptable excipient(s).

The present invention further provides an apparatus for stretching and/or deforming a substrate to the final or near-final shape prior to or during drilling.

In one embodiment, the substrate is pulled in at least two directions in the same plane causing stretching and/or deformation. In another embodiment, the substrate is pulled in at least two directions in at least two different planes causing stretching and/or deformation.

The present invention can also provide an apparatus and method for drilling nozzles in substrates wherein the nozzles are oriented in such a way as to provide impinging jets upon moving fluid through the nozzles which can more easily facilitate the formation of an aerosol.

Other features and advantages of the present invention will become apparent from the following detailed description, examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The above and other advantages of the invention will be apparent upon consideration of the following detailed description, taken in conjunction with the accompanying drawings, in which the reference characters refer to like parts throughout and in which:

FIG. 1 shows a substrate pulled in two directions (length and width) containing holes according to an embodiment of the present invention.

FIG. 2 shows a substrate stretched with the aid of a stretching or deforming member in at least two directions containing holes according to an embodiment of the present invention.

FIGS. 3(a) to 3(d) show various steps of stretching or deforming and drilling holes in a substrate according to an embodiment of the present invention.

FIGS. 4 and 5 show alignment of holes in relation to the substrate according to an embodiment of the present invention.

FIGS. 6(a) to 6(e) show different embodiments of stretching members according to various embodiments of the present invention.

FIGS. 7(a) to 7(c) show a different embodiment including a “bump” in the substrate, and further enlargements of the nozzle area which includes nozzles oriented for fluid impingement.

FIG. 8 shows an embodiment of a magnified view of two nozzles oriented for fluid impingement.

FIG. 9 shows cross-sectional view of the substrate shown in FIG. 8 along line IX.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

It is noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### Drill-After-Stretch (DAS) and Drill-After-Deformation (DAD) Technology

In one embodiment, the nozzles resulting from the DAS/DAD technology described herein can provide nozzle arrays that do not substantially stretch or enlarge during high pressure operation. Thus, the functional hole size (i.e., the stretched or deformed nozzle hole size present when the device is actually generating aerosol) is substantially the same as the actual drilled hole size. Thus, drilling holes using the DAS/DAD technology can provide substantially smaller aerosol particle size when compared to conventional drilling (i.e., without stretching or deforming). For example, a substrate drilled with an approximately 1.15 micrometer exit hole diameter without using DAS/DAD technology, can stretch or deform to approximately 1.8 micrometer diameter during use. However, nozzles drilled by DAS/DAD technology by use of sub-micrometer technology with 0.6 micrometer diameter actual hole size can provide a substantially similar functional hole size (i.e., ˜0.6 micrometer diameter), providing a 3× diameter reduction in functional hole size. Thus, by using DAS/DAD technology to reduce functional hole sizes can provide particles small enough to substantially eliminate the requirement of a heater for size reduction of aerosolized particles.

### Jet Impingement Technology

Jet impingement is a further process of producing aerosol by colliding or impinging two or more liquid jets in free space. In this way, the kinetic energy present in the jet can be used to create aerosol. Additionally, by using jet kinetic energy to assist in aerosol formation, lower aerosol velocities (and consequently lower fluid pressures behind the nozzle) can be generated, allowing, among other things, greater flexibility in device airway design. Finally, larger jet hole sizes may be possible for a given aerosol particle size, resulting in lower operating pressures with subsequent improvements in reliability, repeatability, and cost.

The present invention provides, in one embodiment, in place of, or in combination with the DAS/DAD technology, the aligning of nozzles such that they force jet impingement in free space above the membrane. In addition, the present invention provides, in one embodiment, that metal and/or composite DAS/DAD membranes may be drilled with closely spaced holes to allow additional angular misalignment of impinging jets.

It should be noted that any combination of DAS/DAD technology and/or jet impingement technology can be utilized in the present invention. However, utilizing jet impingement technology in combination with, or in lieu of DAS/DAD technology can provide several important advantages.

For example, jet impingement technology can be simple and robust. As described herein, the jet forming membrane (or substrate) can be inexpensive and amenable to high volume disposable production. The volume contained within the actual jets can be small, thereby improving the possibility of maintaining sterility in a reusable system and resisting nozzle plugging. Moreover, with metal membranes (substrates), the system can be sufficiently durable to allow reuse multiple times. Thus, combining jet impingement technology with DAS/DAD technology, may result in a unique, not heretofore known system that maintains the above noted advantages, but can additionally include:

1. Low velocity aerosol generation—Low velocity aerosol generation can improve the final configuration, by minimizing or altogether eliminating the requirement of a high velocity airway typically utilized with DAS/DAD technology.

2. Larger hole sizes—Using the jet kinetic energy to assist in aerosol creation may allow larger hole sizes and reduce aerosol variability derived from hole size variation.

3. Lower operating pressures—Larger hole sizes operate at lower jetting pressures. Because impinging jet technology typically does not require small hole sizes to generate small particle sizes, a potentially better, simpler, more stable device design can be provided.

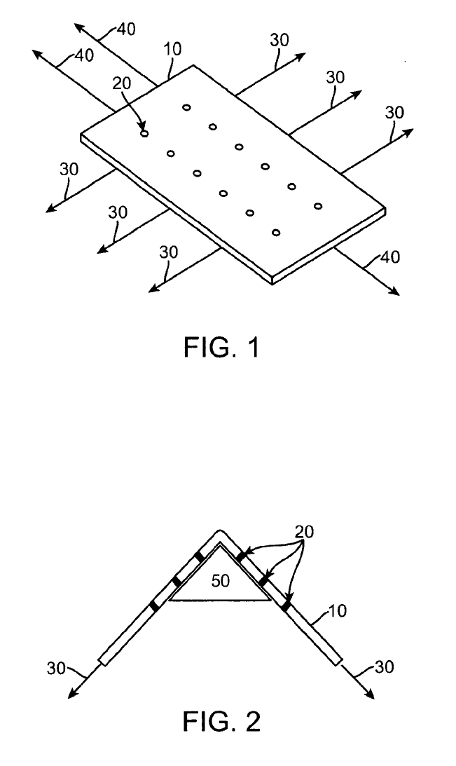

Turning to the accompanying figures, FIG. 1 depicts substrate 10 which is pulled in at least two directions 30, 40, and which further contains a plurality of holes 20, thereby causing stretching or deformation.

The present invention contemplates that substrate 10 can include any material(s) capable of formation of via or blind holes. For example, substrate 10 can include a multilayer membrane containing polymers and/or metals. In one embodiment of the present invention, substrate 10 can include a single-layer or laminate of aluminum, manganese, beryllium, tantalum, titanium, iron, zinc, zirconium, copper, lead, stainless steel, nickel, or alloys of the foregoing metals in combination with conventionally known alloying elements or compounds. In one embodiment, the metal layer(s) can include metal foil(s) of nickel in a thickness of approximately 0.001″ thickness (or about 25.4 micrometers).

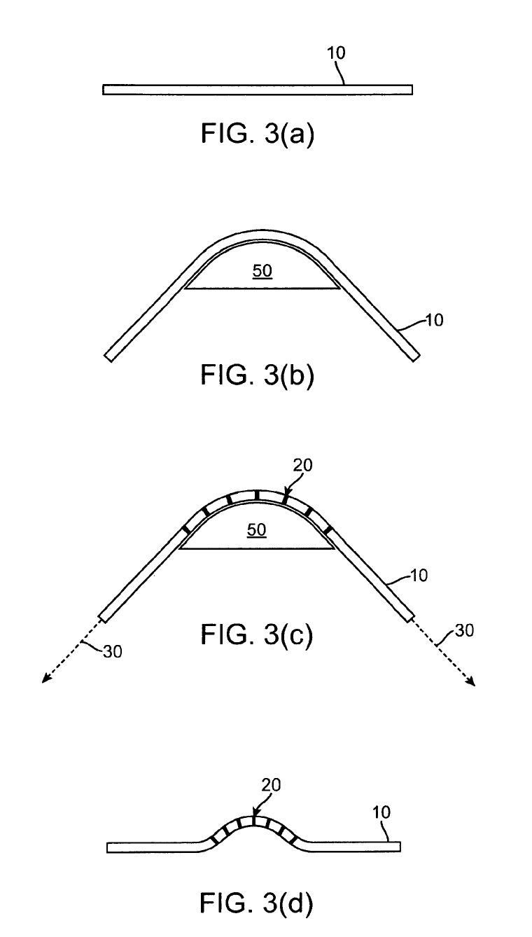

In one embodiment, the substrate 10 can be pulled in at least two directions in the same plane, as shown for example by numerals 30 or 40 of FIG. 1, thereby causing stretching and/or deformation. In another embodiment, the substrate 10 can be pulled in at least two directions in at least two different planes, as shown for example by numerals 30 in FIG. 2 and FIG. 3(c), thereby causing stretching and/or deformation. In a further embodiment, the substrate can be pulled in at least three directions, thereby causing stretching and/or deformation. In yet a further embodiment, each direction of stretching can be normal (i.e., perpendicular) to the other, such as when pulling in at least three different directions the force would be applied similar to that of the x, y, and z axis of a three dimensional Cartesian coordinate system.

FIG. 2 depicts substrate 10 being pulled in at least two different directions 30 over a stretching member 50, which can be shaped to produce localized stretching and/or deformation effects of the substrate 10. Thus, in one embodiment, after sufficient pulling of the substrate 10, the holes 20 can be drilled in the substrate. A further embodiment provides that the substrate 10 can optionally be relaxed following hole formation. In one embodiment, the substrate can be pre-stretched thereby causing permanent deformation. Such permanent deformation can result in partial stretching, i.e., the substrate is pulled and stretched to a state where holes are drilled, and the substrate relaxes to a state providing smaller holes than the drilled hole size, but wherein the substrate is permanently deformed from its original state.

In one embodiment, relaxing of the substrate 10 following hole formation can provide effective holes smaller than the functional size of the holes and drilling apparatus. That is, if the drilling apparatus can form holes for example, of approximately 1 micrometer in diameter, and the substrate 10 is stretched by 20% in the area of the hole formation, after pulling of the substrate 10 and drilling the hole(s) 20, the substrate can be relaxed resulting in an effective hole size that is effectively 20% smaller in diameter than the drilling apparatus (˜0.80 micrometer).

The present invention contemplates a drilling apparatus that can drill holes of any size. Thus, while micrometer or sub-micrometer sized hole drilling LASER technology are most preferred, the present invention is not limited thereto. For example, other technologies used for hole drilling such as ion beams and electron beams are also contemplated by the present invention. Such examples are gallium ion beam (or focused ion beam—FIB) drills which can drill nanometer sized holes or shapes in the substrate.

In addition, the shape of the holes in the substrate are not limited to circular holes (i.e., cylinders with a square or rectangular cross-section taken parallel to the hole axis). Thus, “holes” as defined herein can have a cross section—parallel and/or perpendicular to the hole axis—which is square, rectangular, conical, frusto-conical, trapezoidal, hour-glass, half-hour glass, or any combination thereof. The hole shape and resultant cross-section is not particularly limited. Thus, any combination of cross sections—when viewed parallel and/or perpendicular to the hole axis—is contemplated. The most preferred combination of cross-sections are frusto-conical (with cross-section parallel to the hole axis), circular (with cross-section perpendicular to the hole axis), and/or oval (with cross-section perpendicular to the hole axis). Although preferred hole shape and cross-section may depend on the desired transport and fluid flow properties through the hole.

In a further embodiment, the holes 20 can be formed in the substrate 10 in an array having a plurality of holes. In yet a further embodiment, the array can contain different size and/or shaped holes at different positions.

FIGS. 3(a)-3(d) depict an embodiment including varying steps in pulling and forming holes in a substrate 10. For example, FIG. 3(a) depicts a flat substrate 10 prior to pulling and hole formation. FIG. 3(b) depicts and applying a stretching/deforming member 50 to the substrate 10 prior to pulling and hole formation. FIG. 3(c) depicts the pulling of substrate 10 in at least two directions 30 over stretching/deforming member 50. In one embodiment, substrate holder (not shown) can hold the substrate 10 and/or stretching/deforming member 50 to facilitate the stretching, pre-stretching, or pulling of substrate 10.

In another embodiment, the substrate 10 can be pulled to a final or near final pressurized operating shape prior to drilling. This may be accomplished for example, in any number ways. In one example, the substrate 10 may be clamped in a substrate holder (not shown) which holds the substrate 10, where an area including at least the area where holes are to be drilled into the substrate 10 can be inflated with air to stretch it to final shape. These pressurized nozzle “blisters” can be then drilled and then deflated, resulting in a structure shown for example in FIG. 3(d).

The substrate 10 can also be stretched and/or deformed to a final or near final pressurized operating shape prior to drilling by providing a clamping assembly (not shown) around stretching/deforming member 50 to mechanically deform nozzle areas. In this technique, a stretching/deforming member 50 is forced into the substrate 10 with a suitable clamp resulting in localized stretching and/or deforming of the substrate 10. This causes the membrane to stretch and/or deform to substantially the shape of the stretching member 50. While clamped to the stretching/deforming member 50, the now curved substrate 10 can then be drilled.

Lastly, substrate 10 can be stretched and/or deformed to a final or near final pressurized operating shape prior to drilling similar to the technique of using a claming assembly and stretching/deforming member as noted above, but instead the substrate 10 can be removed from the form prior to drilling. This embodiment can provide permanent nozzle “bumps” in the substrate 10 prior to drilling. These preformed bumps can be shaped to minimize stretching and/or deformation when assembled into strips and subsequently pressurized.

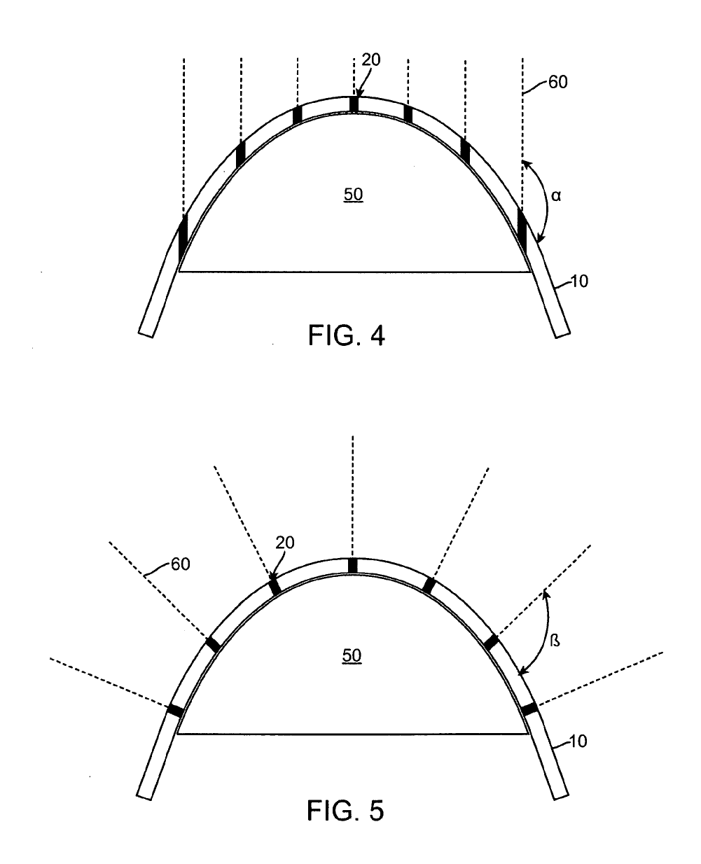

In another embodiment, as shown for example in FIG. 4, nozzle holes 20 can have various alignment in relation to substrate 10. For example, FIG. 4 depicts nozzle hole axis 60 remaining constant over the surface of substrate 10. That is, the angle (α) between the surface of the substrate 10 and nozzle hole axis 60 continuously across the substrate surface in the area where nozzle holes are drilled.

In another embodiment, as shown for example in FIG. 5, nozzle holes 20 can have constant alignment in relation to the substrate 10. For example, FIG. 5 depicts nozzle hole axis 60 changing over the surface of substrate 10. That is, the angle (β) between the surface of the substrate 10 and the nozzle hole axis remains constant at approximately 90 degrees (i.e., normal) across the substrate surface in the area where nozzle holes are drilled.

The present invention contemplates that stretching/deforming member 50 may be formed of any material sufficient to cause stretching and/or deformation of the substrate 10. However, the stretching/deforming member 50 is preferably formed from a transparent material, such as quartz. A stretching/deforming member 50 made from quartz is most preferred because it can be configured to monitor the feedback of a drilling process of drilling holes 20 in the substrate 10. For example, a feedback apparatus (not shown) can be attached to stretching/deforming member 50 to monitor when a drill (e.g., a LASER drill) has moved completely through substrate 50.

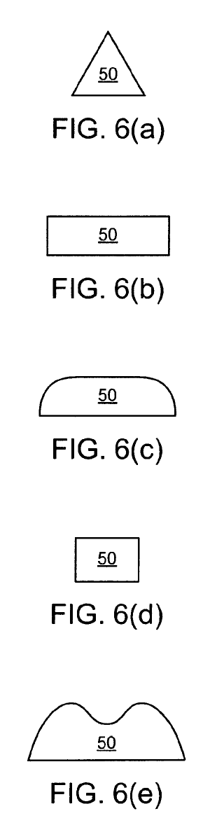

FIGS. 6(a) to 6(e) depict examples of shapes of representative stretching/deforming member(s) 50. For example, stretching/deforming member 50 can be in the shape of a cone or triangle (FIG. 6(a)), trapezoid (FIG. 6(b)), trapezoid with rounded edges (FIG. 6(c)), square (FIG. 6(d)), or camel back shaped (FIG. 6(e)). In addition, stretching/deforming member 50 can also be semispherical (e.g., in FIGS. 3(b)-3(c); FIGS. 4-5). While FIGS. 6(a)-6(e) depict shapes of representative stretching members, the present invention contemplates that stretching/deforming member 50 can be made from any shape that forms the desired pattern or shape in substrate 10.

DAS/DAD technology as disclosed herein, and applied to the production of existing laminated strip products, may also provide improved physical and structural results. For example, it is contemplated that strips produced in accordance with the present invention should provide for a more stable hole size, and should exhibit less extrusion pressure variation and therefore less dose variability.

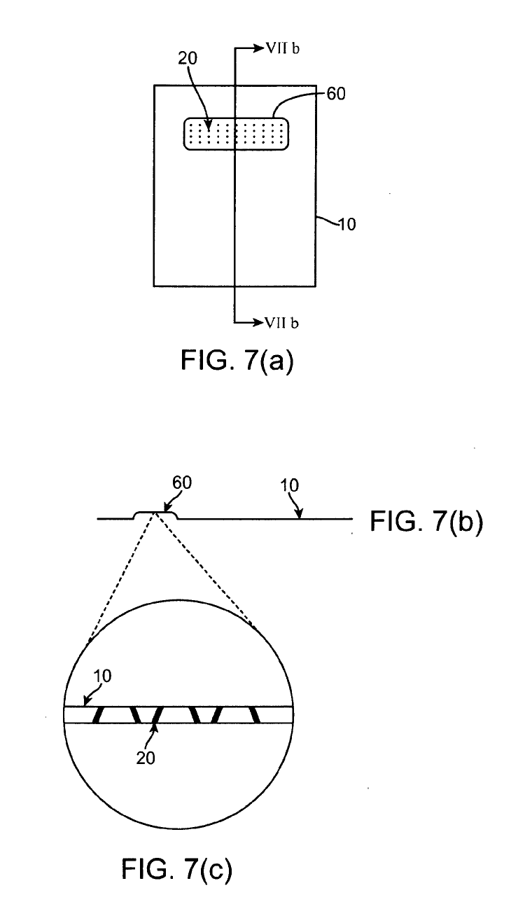

FIGS. 7(a) to 7(c) show an embodiment including a “bump” in the substrate, and further enlargements of the nozzle area which includes nozzles oriented for fluid flow impingement. In this example, FIG. 7(a) represents a top view of a substrate 10, bump 60, and holes 20. FIG. 7(b) represents a cross section, along line VII(b) showing the relative height of bump 60 in relation to the remainder of the surface of the substrate 10. It should be noted that the bump 60 height is not necessarily to scale, and thus is for illustrative and example purposes only.

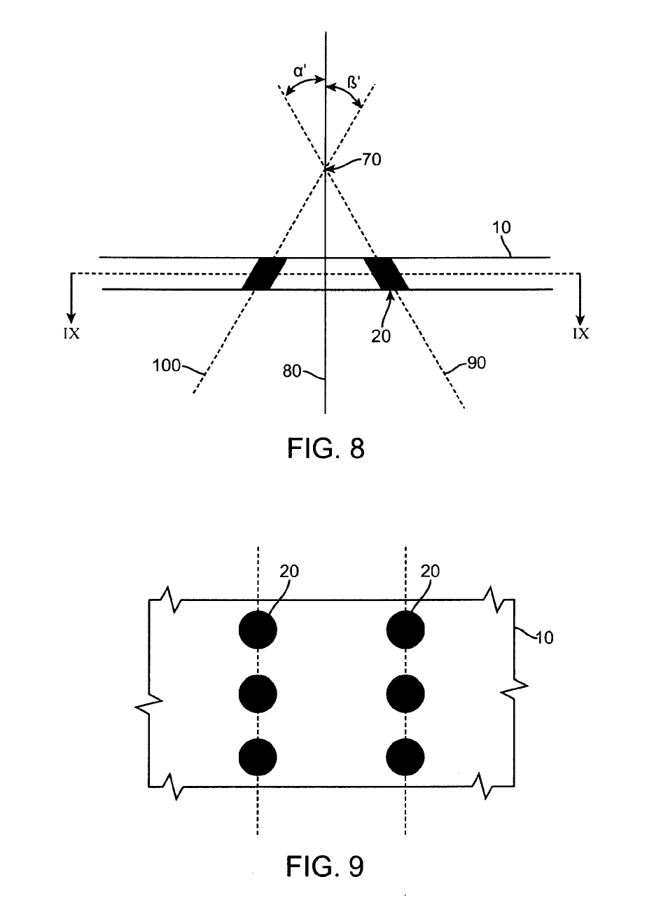

For example, the DAS/DAD membrane can be formed from approximately 0.001″ (25 micron) thickness stainless steel wherein the DAS/DAD shape is in the form of a “bump”, i.e., for example, a ½ cylinder shape roughly 0.23″ long by 0.07″ wide with rounded ends (see, e.g., numeral 60 in FIG. 7(a)). The DAS/DAD membrane can be drilled with an array of nozzles, as previously described, except that alternate rows are drilled from about 30 to about 80 degrees from normal (i.e., perpendicular from the membrane surface—shown for example as 80 in FIG. 8) so as to cause alternate jet rows to provide impingement above the membrane when fluid is passed through the nozzles. For example, nozzles or hole(s) 20 are depicted in FIG. 7(c), and are shown simply as dots (20) in FIG. 7(a).

FIG. 8 shows an embodiment of a magnified view of two nozzles oriented for fluid impingement. For example, in FIG. 8, the substrate 10 includes at least two holes 20, which are oriented at an angle from normal axis 80, such that fluid flowing through the holes 20 would impinge at approximately impingement point 70. The hole axes (90, 100) are at an angle (α′ and β′, respectively) from normal axis 80. It should be noted that angles α′ and β′ can be from about 30 to about 80 degrees.

It should be noted that the shape and/or cross-section of the holes oriented for fluid impingement are not limited to circular holes (i.e., cylinders with a square or rectangular cross-section taken parallel to the hole axis). Thus, “holes” oriented for fluid impingement are contemplated as having a cross section—parallel and/or perpendicular to the hole axis—which is square, rectangular, conical, frusto-conical, trapezoidal, hour-glass, half-hour glass, or any combination thereof. The hole shape and resultant cross-section is not particularly limited. Thus, any combination of cross sections—when viewed parallel and/or perpendicular to the hole axis—is contemplated. The most preferred combination of cross-sections are frusto-conical (with cross-section parallel to the hole axis), circular (with cross-section perpendicular to the hole axis), and/or oval (with cross-section perpendicular to the hole axis). Although preferred hole shape and cross-section may depend on the desired transport and fluid flow properties through the hole.

As an example, FIG. 9 depicts a cross-section view of the substrate in FIG. 8, taken at line IX. FIG. 9 shows substrate 10 containing a plurality of holes 20, which are ovalized, on account of the off axis drilling of holes 20, which can be more readily viewed in FIG. 8. The present invention contemplates that holes 20 can be the same or different sizes, that is, the specific hole size (e.g., diameter) can be tailored to location within the array, or it can be random. Thus, variable hole size can be used to make the resultant aerosol contain more size variation in particles when compared to having uniform hole sizes (e.g., diameter) throughout the array. It should be understood that substrate 20 in FIG. 9 can continues in both directions of what can be considered to be the x- and y-axes, thus, FIG. 9 depicts just a small part of the substrate 20.

Further, when an amount, size, or other value or parameter, is given as a list of upper preferable values and lower preferable values, this is to be understood as specifically disclosing all ranges formed from any pair of an upper preferred value and a lower preferred value, regardless whether ranges are separately disclosed.

1. A method of drilling a plurality of holes in a stretched substrate, comprising:
providing a substrate in a substrate holder;
stretching the substrate in a first direction and in a second direction wherein the first direction and second direction are in different planes to obtain a stretched configuration; and
drilling a plurality of holes in the substrate while the substrate is in the stretched configuration.

2. The method of claim 1, wherein the first direction is normal to the second direction.

3. The method of claims 1, further comprising:
stretching the substrate in a third direction which is different from the first and second directions.

4. The method of claim 3, wherein the first and third directions are normal relative to the second direction.

5. The method of claim 1, further comprising:
releasing the substrate from the stretched configuration.

6. The method of claim 1, wherein the plurality of holes are drilled in the substrate using a laser.

7. The method of claim 1, wherein at least two of the holes are drilled and aligned such that when forcing a fluid through the holes in the substrate, the fluid impinges and forms an aerosol.

8. The method of claim 7, wherein the at least two holes are aligned such that the axes of the at least two holes form an angle of between about 30 degrees to about 80 degrees from normal.

9. The method of claim 8, wherein the axes of the at least two holes form an angle of between about 40 degrees to about 70 degrees from normal.

10. An apparatus for providing an aerosol from a fluid, the apparatus comprising:
a substrate produced by stretching the substrate in a first direction and in a second direction wherein the first direction and second direction are in different planes to obtain a stretched configuration;
drilling a plurality of holes in the substrate while the substrate is in the stretched configuration; and
a reservoir for holding the fluid.

11. A method of forming an aerosol from a liquid, comprising:
providing a substrate produced by stretching the substrate in a first direction and in a second direction wherein the first direction and second direction are in different planes to obtain a stretched configuration;
drilling a plurality of holes in the substrate while the substrate is in the stretched configuration; and
forcing the fluid through the substrate to make an aerosol.

12. The method of claim 11, wherein the fluid comprises an active ingredient and a pharmaceutically acceptable excipient.

13. The method of claim 12, wherein the active ingredient is selected from the group consisting of GLP-1, insulin, growth hormones, interferon, and cytokine.

14. The method of claim 13, wherein the insulin is selected from the group consisting of human insulin, and an analog thereof.
